(19) United States
(12) Patent Application Publication
(10) Pub. No.: US 2019/0180348 A1
(43) Pub. Date: Jun. 13, 2019

(54) METHODS AND SYSTEMS FOR PROCESSING A TRANSACTION REQUEST

(71) Applicant: MASTERCARD INTERNATIONAL INCORPORATED, Purchase, NY (US)

(72) Inventor: Vigneshwaran VASANTHARAJAN, Villupuram (IN)

(21) Appl. No.: 16/204,569

(22) Filed: Nov. 29, 2018

(30) Foreign Application Priority Data
Dec. 12, 2017 (SG) 10201710333Q

(51) Int. Cl. G06Q 30/06; G06Q 10/08

(52) U.S. Cl. CPC G06Q 30/0635; G06Q 10/0836

(57) ABSTRACT

A computer-implemented method for processing a transaction request at a payee location using a payer transaction module, where the payer transaction module is in communication with a payment network server, comprises receiving, at the payer transaction module effecting on a payer device, a transaction request indicating a first product and a second product to be purchased from a payee, the first product having a first delivery option and the second product having a second delivery option; forwarding, to the payment network server, the transaction request; and receiving, at the payer transaction module, a response message to process the transaction request if it is determined at the payment network server that the payee is available to carry out the first and second delivery options for delivering the first and second products respectively.

### FIELD OF INVENTION

The present invention relates broadly, but not exclusively, to methods and systems for processing a transaction request for purchasing a product at a payee location (e.g., a retail location).

### BACKGROUND

Conventionally, consumers have to purchase at local retailers by waiting in a shopping line and paying at a checkout counter. The entire shopping process was based on an individual's searching a store for consumables. Customer service was limited to retail merchants directing consumers through the store, or helping when asked. The entire retail experience was alienating, time-intensive and often confusing.

In recent times, mobile shopping applications have become more popular. Such applications allow consumers to compare and manage shopping lists for products such as groceries, office supplies, home accessories, gardening supplies, etc. That is, a mobile shopping application is only for use with a specific merchant. However, a different mobile shopping application has to be downloaded for each retailer. In the event that the consumers would like to browse through items at a new merchant, a new mobile shopping application has to be first downloaded, even if the consumers do not end up making any new purchases at the new merchant. Shopping in this manner consumes too much memory on the consumers' mobile devices.

Moreover, the delivery option for all items in a single request is typically limited to either pick-up from the store or home delivery. It does not provide the consumers any flexibility to indicate a preferred delivery option for each item in one request. Such a delivery process is inflexible and does not fully utilize the resources that a merchant may have.

In view of the above, it would be desirable to provide a method and a system for processing a transaction request, which overcome one or more of the above disadvantages or which at least provides a useful alternative.

Furthermore, other desirable features and characteristics will become apparent from the subsequent detailed description and the appended claims, taken in conjunction with the accompanying drawings and this background of the disclosure.

### BRIEF SUMMARY

According to a first aspect, there is provided a computer-implemented method for processing a transaction request at a payee location using a payer transaction module, the payer transaction module in communication with a payment network server, the method comprising receiving, at the payer transaction module effecting on a payer device, a transaction request indicating a first product and a second product to be purchased from a payee, the first product having a first delivery option and the second product having a second delivery option; forwarding, to the payment network server, the transaction request; and receiving, at the payer transaction module, a response message to process the transaction request if it is determined at the payment network server that the payee is available to carry out the first and second delivery options for delivering the first and second products respectively.

According to a second aspect, there is provided a server for processing a transaction request at a payee location using a payer transaction module, the server comprising: at least one processor; and at least one memory including computer program code; the at least one memory and the computer program code configured to, with at least one processor, causes the server at least to: receive, from a payer transaction module effecting on a payer device, a transaction request indicating a first product and a second product to be purchased from a payee, the first product having a first delivery option and the second product having a second delivery option; determine if the payee is available to carry out the first and second delivery options for delivering the first and the second products, respectively; and send, to the payer transaction module, a response message to process the transaction request if it is determined that the payee is available to carry out the first and second delivery options for delivering the first and the second products, respectively.

According to a third aspect, there is provided a computer-implemented method for processing a transaction request at a payee location using a payer transaction module, the method comprising receiving a selection of a first product; displaying a list of delivery options for the first product, the list of delivery options comprising (i) a home delivery option within a city in which the payee location is at, (ii) a take home option and (iii) a delivery option outside a country in which the payee location is at; receiving an input indicating a first delivery option; associating the first product with the first delivery option; receiving a selection of a second product; displaying the list of delivery options for the second product; receiving an input indicating a second delivery option, wherein the second delivery option is different than first delivery option; and associating the second product with the second delivery option.

According to a fourth aspect, there is provided a computer-implemented method for processing a transaction request at a payee location using a payer transaction module, the payer transaction module in communication with a payment network server, the method comprising receiving, at the payer transaction module effecting on a payer device, a transaction request indicating a first product and a second product to be purchased from a payee, the first product having a take away option and the second product having a home delivery option; forwarding, to the payment network server, the transaction request; and receiving, at the payer transaction module, a response message to process the transaction request if it is determined at the payment network server that the payee is available to carry out the home delivery option for delivering the second product.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1A illustrates a block diagram of a transaction system within which transaction data can be received.

FIG. 1B shows a payment network server for processing a transaction request at a payee location using a payer transaction module according to various embodiments.

FIG. 2A shows a flow chart illustrating a computer-implemented method for processing a transaction request at a payee location using a payer transaction module which is in communication with a payment network server.

FIG. 2B illustrates an example of how the payer and the payee may register or use the payer transaction module and the payee transaction module respectively.

FIG. 2C illustrates an example of how the payer and the payee may use the payer transaction module and the payee transaction module, respectively, where the payee offers a list of delivery options.

FIG. 2D illustrates a flow chart illustrating a computer-implemented method, executing on a user device, for presenting capabilities to a payer to select a different delivery option for a different product using a payer transaction module.

FIG. 3 depicts a computing device which may be used to facilitate execution of the above-described method in FIG. 2A.

FIG. 4 shows an example of the payment network server as shown in FIG. 1A.

### DETAILED DESCRIPTION

Various embodiments provide devices and methods for processing a transaction request, which may be referred to as a purchase transaction request using a payer transaction module (or a mobile shopping application).

A payer transaction module is provided in association with a payer device (or a user device or a mobile device) for shopping at a payee (or a merchant).

According to various embodiments, devices and methods are provided with which a payer can initiate a transaction request, using a payer transaction module executing on a payer device, to purchase one or more products at a premise of a payee (or merchant). The payer can also indicate a preferred delivery option for delivering each of the one or more products in the transaction request and make payment when it is determined that the payee is available to carry out the corresponding preferred delivery option. For example, if a payer would like to purchase a pair of socks and a pair of sneakers with different delivery options then this can be achieved using various embodiments. He can take home the pair of socks after making payment and can send the pair of sneakers to a friend who is staying overseas.

Advantageously, various embodiments can provide the payer an option to indicate one or more preferred delivery options, at the premise of a payee, in a single transaction request using a payer transaction module that can be used at one or more payees who are users of the corresponding payee transaction module. This helps to save memory on the payer's device and makes the whole shopping experience fuss-free.

Advantageously, with the devices and methods according to various embodiments, payers have the option to select a preferred delivery option for each product in a single transaction request using a mobile shopping application that is compatible with one or more merchants. This is great usage for those who prefer shopping applications, yet shop at a premise of a payee, and purchase different products to be sent to different locations.

### Terms Description (in Addition to Plain and Dictionary Meaning of Terms)

A payer transaction module is an application associated with a transaction function, e.g., shopping, and may be one that supports payment to settle the transaction. For example, the payer transaction module may be an extension of an existing payment module, e.g., Masterpass®, which is a digital payment service from Mastercard® that provides fast, simple and secure digital payments across devices and channels. Alternatively, the payer transaction module is one, separate from the payment module that supports a switch to the payment module to settle the transaction at an appropriate stage of the transaction. The payer transaction module is one that may be used at the premise of a payee who is a registered user of the payee transaction module. In other words, the payer transaction module is one that can be used at the premise of one or more payees.

A payee transaction module is an application that is associated with a payee (who is a registered user), and may be one that supports additional services like payment to settle a transaction or scanning service.

A payment network server typically is associated with a payment facilitator. For example, the payment network server may be the Banknet® network operated by MasterCard®. The payment facilitator (e.g. MasterCard®) may be an entity (e.g. a company or organization) who operates to process transactions, clear and settle funds for payments between two entities (e.g. two banks). The payment network server may include one or more computing devices that are used for processing transactions. In specific implementations, the payment network server is further configured to perform additional operations. For example, the payment network server may be configured to update the database whenever a user (e.g., a payer or a payee) registers for a module (e.g., a payer shopping mobile application or a payee shopping mobile application). Additionally, the payment network server may also be configured to determine if a payee is available to carry out a corresponding delivery option for delivering each of the one or more products indicated in the transaction request.

A preferred delivery option may refer to the first choice, among those that are available, of a payer for delivering a product. For example, if first and second products are selected, a corresponding preferred delivery option for each of the first and second products may be a first delivery option and a second delivery option. For various embodiments, the list of delivery options comprises (i) a home delivery option within a city in which the payee location is at, (ii) a take home option and (iii) a home delivery option outside a country in which the payee location is at.

An alternative delivery option may refer to the second choice, among those that are available, of a payer for delivering a product when the first choice (e.g., a first delivery option like home delivery option for the first product) is not available. For various embodiments, the alternative delivery option is another one from the list of delivery options comprises (i) a home delivery option within a city in which the payee location is at, (ii) a take home option and (iii) a home delivery option outside a country in which the payee location is at.

Various credit cards and debit cards of a user may be managed in a user's e-wallet (electronic wallet), which may be referred to as “wallet” for short. An example of an e-wallet is Masterpass®, which is a digital payment service from Mastercard® that provides fast, simple and secure digital payments across devices and channels. Masterpass® for example provides an interface for selecting which card of a plurality of cards that a user holds to use for a certain transaction and allows a convenient cashless payment.

### Example Embodiments

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “analyzing”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

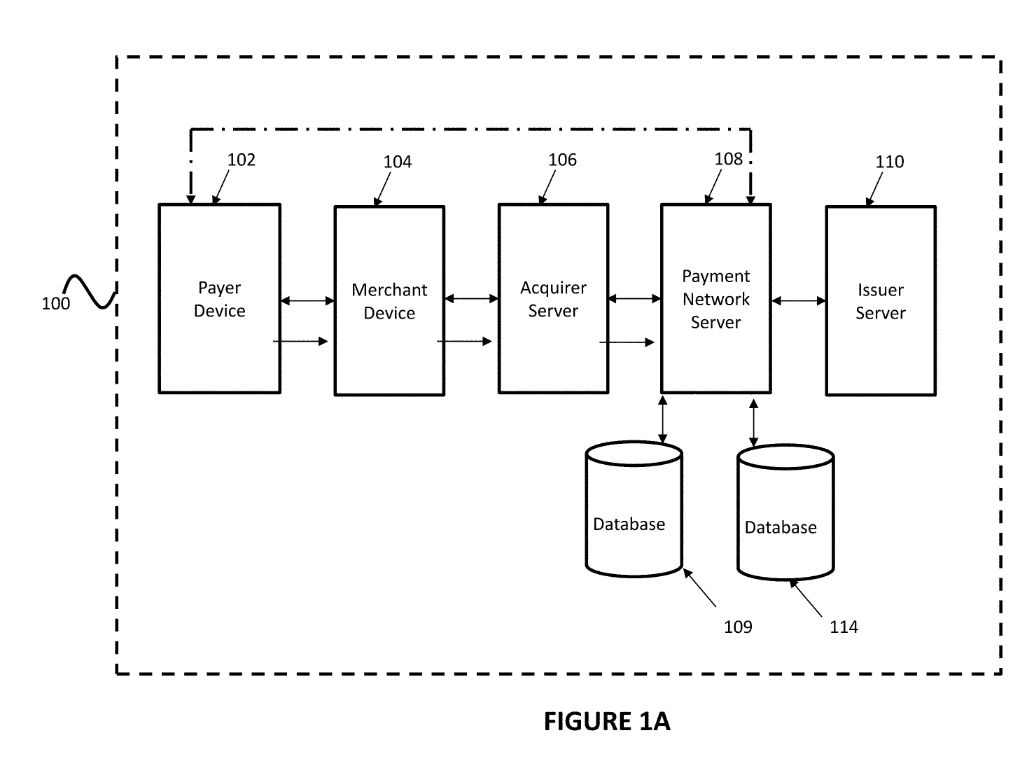

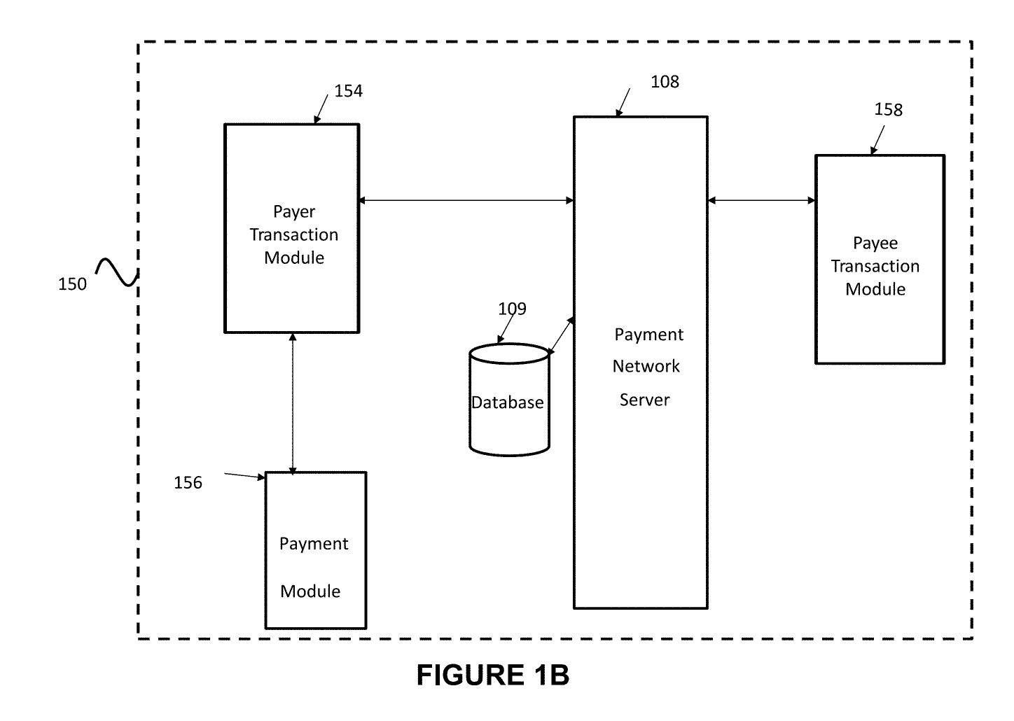

FIG. 1A illustrates a block diagram of a transaction system 100 within which transaction data can be received.

The system 100 comprises a payer device 102 in communication with a payee device 104. The payer device 102 may also be in direct communication with a payment network server 108, without having to communicate with the payee device 104.

The payee device 104 is in communication with an acquirer server 106. The acquirer server 106, in turn, is in communication with the payment network server 108. The payment network server 108, in turn, is in communication with an issuer server 110.

The payer device 102 typically is associated with a customer (or payer) who is a party to a transaction that occurs between the payer device 102 and the payee device 104. The payer device 102 may be a fixed (wired) computing device or a wireless (portable) computing device. In specific implementations, the payer device 102 may be a handheld or portable or mobile device carried or used by the customer, or may refer to other types of electronic devices such as a personal computer, a land-line telephone or an interactive voice response (IVR) system and the like. The mobile device may be a device, such as a mobile phone, a laptop computer, a personal digital computer (PDA), a mobile computer, a portable music player (such as an iPod™ and the like).

The payee device 104 typically is associated with the merchant who is also a party to the transaction that occurs between the payer device 102 and the payee device 104 through the transaction. The payee device 104 may be a point-of-sale (POS) terminal, an automatic teller machine (ATM), a personal computer, a computer server (hosting a website, for example), an IVR system, a land-line telephone, or any type of mobile device such as a mobile phone, a personal digital assistant (PDA), a laptop computer, a tablet computer and the like.

The acquirer server 106 generally is associated with an acquirer who may be an entity (e.g. a company or organization) which issues (e.g. establishes, manages, administers) a transaction credential or an account (e.g. a financial bank account) of the merchant. Examples of the acquirer include a bank and/or other financial institution. As stated in the above, the acquirer server 106 may include one or more computing devices that are used to establish communication with another server by exchanging messages with and/or passing information to the other server.

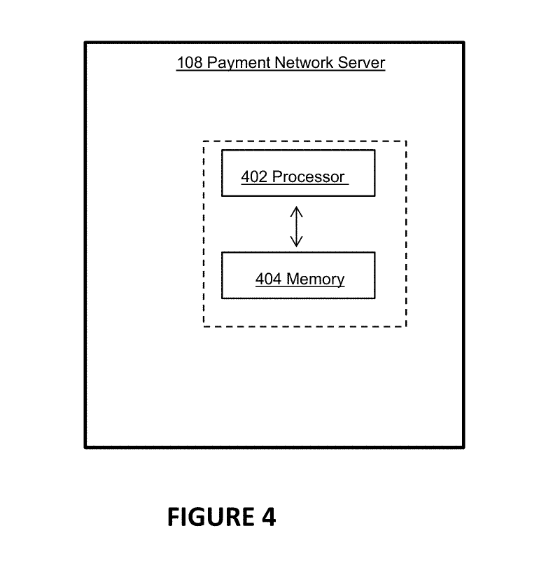

The payment network server 108 typically is associated with a payment facilitator. For example, the payment network server 108 may be the Banknet® network operated by MasterCard®. The payment facilitator (e.g. MasterCard®) may be an entity (e.g. a company or organization) who operates to process transactions, clear and settle funds for payments between two entities (e.g. two banks). The payment network server 108 may include one or more computing devices that are used for processing transactions. An exemplary payment network server 108 is shown in FIG. 4.

The issuer server 110 generally is associated with an issuer and may include one or more computing devices that are used to perform a payment transaction. The issuer may be an entity (e.g. a company or organization) which issues (e.g. establishes, manages, administers) a transaction credential or an account (e.g. a financial bank account). An account may be associated with a plurality of payer devices 102. That is, a payer may use a plurality of payer devices including, among other things, his mobile phone, his PDA and his laptop to utilize his account.

The payment network server 108 may be configured to communicate with, or may include, a database (or a transaction database) 109. The transaction database 109 stores data corresponding to a transaction (or transaction data). Examples of the data include Transaction ID, Merchant ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant, time and date for which the goods/services relating to the transaction will be delivered, and a corresponding delivery option that has been utilized. In other words, the transaction database 109 stores information that indicates the types of delivery option that a merchant offers.

In specific implementations, the payment network server 108 is further configured to perform additional operations. For example, the payment network server 108 may be configured to update the database 109 whenever a user (e.g., a payer or a payee) registers for a module (e.g., a payer shopping mobile application or a payee shopping mobile application). Additionally, the payment network server 108 may also be configured to determine if a payee is available to carry out a corresponding delivery option for delivering each of the one or more products indicated in the transaction request or group products based on the associating delivery option

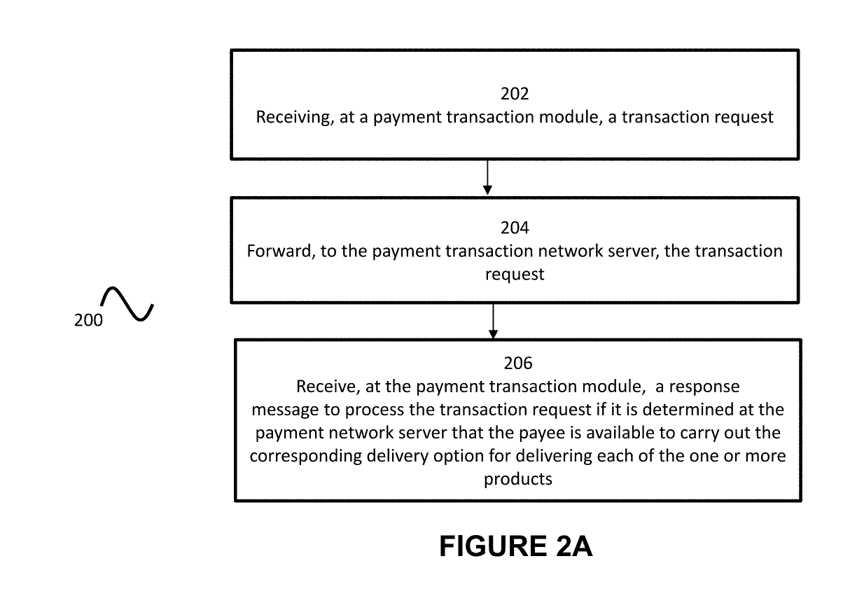

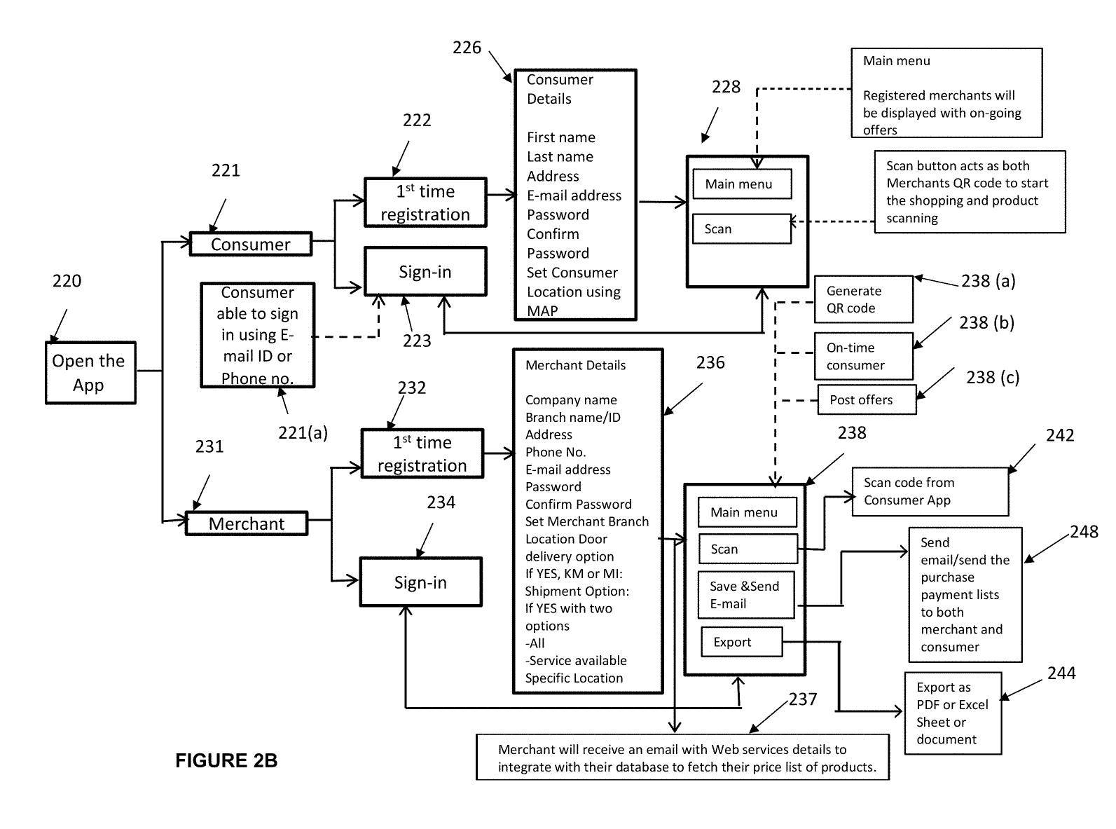

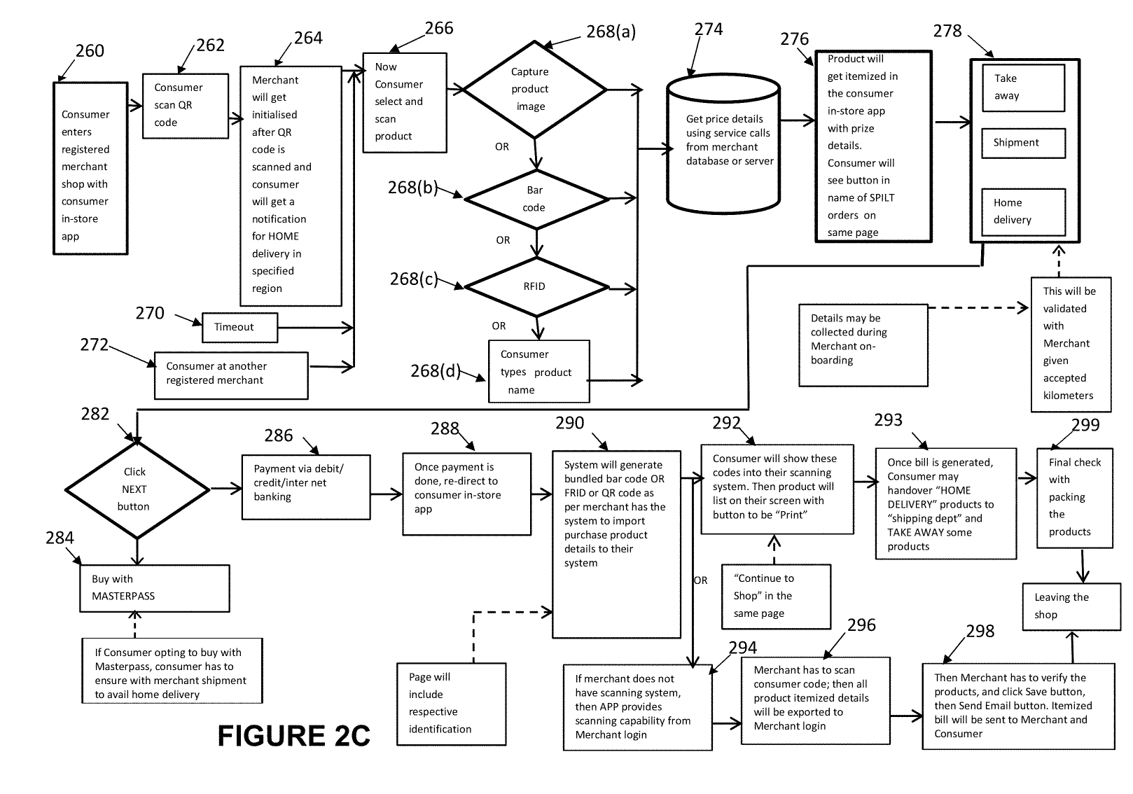

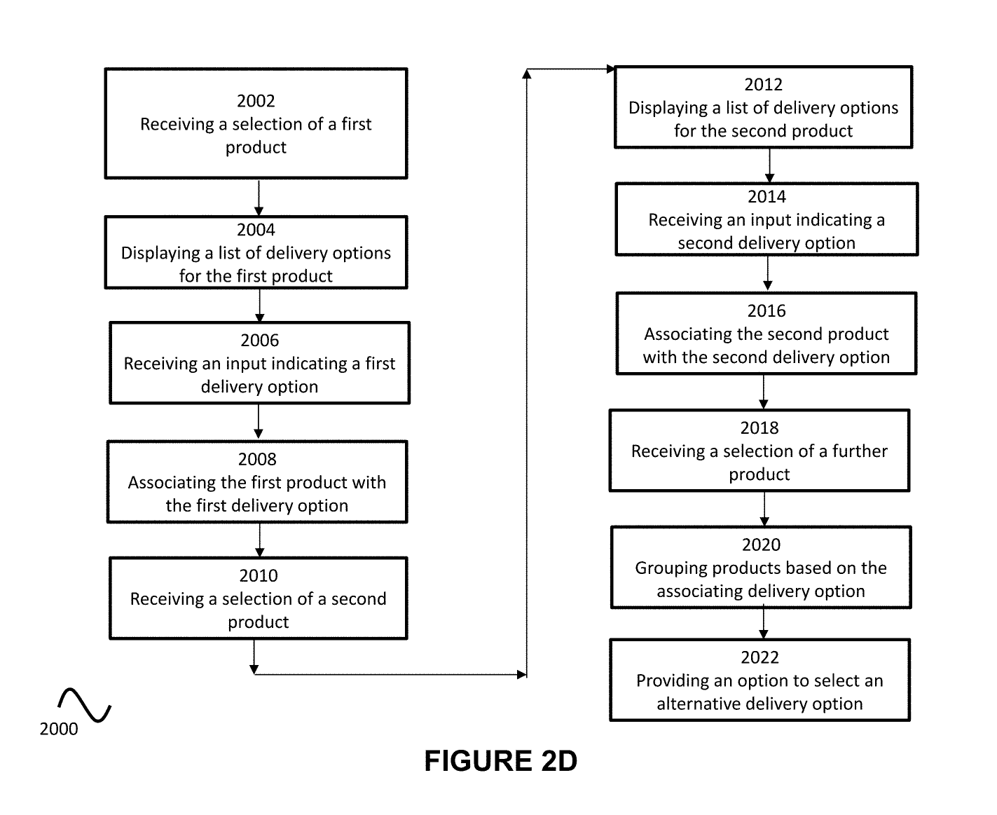

In other embodiments, the payment network server 108 may also be configured to communicate with, or may include, another database 114. The database 114 may include data corresponding to transactions that have been managed using these modules. Examples of the data include name, age group, address, gender, preferred delivery option or the like relating to the payer. Additionally or alternatively, examples of the data may include the delivery option and details of the delivery carried out of the payee. Further details on how these data are managed are described in FIG. 2A below.

The payer device 102 is capable of wireless communication using a suitable protocol with the payee device 104. For example, embodiments may be implemented using payer devices 102 that are capable of communicating with Wi-Fi/Bluetooth-enabled payee devices 104. It will be appreciated by a person skilled in the art that depending on the wireless communication protocol used, appropriate handshaking procedures may need to be carried out to establish communication between the payer device 102 and the payee device 104. For example, in the case of Bluetooth communication, discovery and pairing of the payer device 102 and the payee device 104 may be carried out to establish communication at the premise of the payee.

In an example, during a transaction, a transaction request (or transaction request message) 112 is generated at the payer device 102. The transaction request message 112 is generated by the payer device 102 in response to the customer (or payer) making a selection of a good and/or service (or a product) to be purchased from the merchant (or payee). In other words, the transaction request message 112 relates to a transaction between the payer and the payee, typically at the merchant's retail location (or the payee location). The transaction may be performed via a payer transaction module and/or a payment module (or a payer transaction module) that works with the infrastructure of the payee. In specific implementations, the payer device 102 may be fitted with a wireless communications interface such as a Near Field Communication (NFC) interface to enable the payer device 102 to electronically communicate with the payee device 104 to perform the transaction. NFC is a set of standards to establish radio communication between devices by bringing them into close proximity such as only a few centimeters. NFC standards cover communication protocols and data exchange formats, and are based on radio-frequency identification (RFID) technology.

The transaction request message 112 may include an account identifier identifying a user, user data, a type of transaction and transaction data. For example, a payer may fill in payment data at a website hosted by a merchant via the internet. The payer may fill in the account identifier and the transaction data (or details). The account identifier may refer to various types of accounts that are administered by one or more issuers, which can be used by the payer. The payer data may include the name of the user and the date of expiry of the account (if applicable).

In other words, each transaction data relates to a transaction and identifies the payer and the payee, generally by way of identifiers of each associated with the payer and the payee respectively. Further, the transaction data may also identify the good and/or service to be purchased and a type or nature of the transaction. The transaction data may further identify a value or price of the good and/or service (e.g., a product), a corresponding delivery option for each of the products. The transaction data may also indicate a time and date at which the transaction was initiated by the payer.

As mentioned above, the role of the payment network server 108 is to facilitate communication between the payer device 102 and another server (e.g, an issuer server). Therefore, the payment network server 108 may serve as a means through which the payer server 102 may communicate with the issuer server 110 in a manner that messages may be accepted and forwarded.

FIG. 1B shows a payment network server 108 for processing a transaction request at a payee location using a payer transaction module 154 according to various embodiments. The payment network server 108 includes a processor configured to determine purchasing behavior of a payer who is registered with the payer transaction module 154. The purchasing behavior of the payer may be determined by retrieving, from database 114, historical transaction data for transactions that have been processed by the same payer. Additionally or alternatively, the purchasing behavior of the payer may be determined based on at least one product that has been selected. In response to the purchasing behavior that has been determined, one or more promotions from one or more corresponding payees may be retrieved from database 109 and sent to the payer transaction module 154. The one or more promotions may be provided by the one or more corresponding payees at the time of registering for the payee transaction module. For example, if the payer selects a pair of sneakers as an item to be purchased, the payment network server 108 may determine that the payer is one who is interested in sports apparel and may send promotions relating to socks or other sports apparel via the payer transaction module 154 for displaying on the payer device to the payer. That is, the payer transaction module 154 is configured to receive one or more promotions from a corresponding one or more payees in response to a determination, at the payment network server, of purchasing behavior of a payer.

Additionally or alternatively, the purchasing behavior of the payer may be determined based on a location relating to the corresponding delivery option for delivering the one or more products. In response to the determination, one or more promotions from one or more corresponding payees may be retrieved and sent to the payer transaction module 154. For example, if the payer selects a pair of sneakers as an item to be purchased at a payee location (which is based in India) and selects to have this pair of sneakers delivered to Singapore (e.g., the location where the product will be delivered), the payment network server 108 may determine if there are any other related promotions based on the location. For example, the payment network server 108 may retrieve, from the database 109, promotion information relating to sneakers in Singapore and determine that there is an on-going promotion for the same type of sneakers in Singapore through Amazon® Prime Now. In response to the determination, the payment network server 108 may send one or more promotions relating to the one or more products to the payer transaction module 154. That is, the payer transaction module 154 is configured to receive one or more promotions from a corresponding one or more payees in response to a determination, at the payment network server 108, of the one or more promotions based on a location relating to the corresponding delivery option for delivering the one or more products. In an embodiment, the payment network server 108 may send a message to the payer, via the payer transaction module 154, requesting for a confirmation to accept the lower price of the same good (e.g., the price of the sneaker that is being offered on Amazon® Prime Now).

In various embodiments, the payer transaction module 154 may be configured to receive information relating to the payee. The payer transaction module 154 may be configured to scan a bar code or a QR code placed on a product, at a payee location, that the payer would like to purchase. The information will then be forwarded to the payment network server 108. The payee is a registered user of a payee transaction module 158 and in response to the receipt of the information relating to the payee, the payment network server 108 may retrieve a list of delivery options that the payee offers (e.g., at least one of pick-up, local delivery and overseas delivery) and send it to payer transaction module 154. In an embodiment, the list of delivery options may be displayed before the payer starts to select the products to purchase, prior to initiating a transaction request. In various embodiments, the payee transaction module is a corresponding module of the payer transaction module 154. That is, the payer transaction module 154 may be used at the premise of payees who are registered users of the corresponding payee transaction module 158.

In an embodiment, a payer selects one or more products to purchase, using the payer transaction module 154, by either entering the name of each of these products or scanning each of these products' bar code/QR code. The information, relating to both the product and the payee offering the product, may be sent to the payment network server 108. In response to the receipt of the information, the payment network server 108 may retrieve delivery options that the payee offers. These delivery options may be indicated when the payee registers as a user of the payee transaction module 158. The list of the delivery option may be sent from the payment network server 108 to the payer transaction module 154.

The payer may initiate a transaction request 112, using the payer transaction module 154, indicating one or more products to be purchased from a payee and a corresponding delivery option for delivering each of the one or more products. The corresponding delivery option indicated in the transaction request may be one that is selected out of the delivery options that the payee offers. The transaction request 112 will be forwarded to the payment network server 108 which is configured to determine if the payee is available to carry out the corresponding delivery option for delivering each of the one or more products. That is, in an embodiment, the payee may not indicate the delivery options that it is available to carry out at the time of registering for the payee transaction module 158 and the payment network server 108 may determine the type of delivery options that the payee is available to carry out based on historical transaction data that is retrieved from database 114. Alternatively, while the payee may indicate the types of delivery options (for example, local delivery) that it is available to carry out, the payment network server 108 may be configured to determine if the payee is available to deliver based on the location at which the product is scheduled. The types of delivery options comprises (i) a home delivery option within a city in which the payee location is at, (ii) a take home option and (iii) a delivery option outside a country in which the payee location is at. This may be done in response to a determination of distance from the payee location and the location at which the product is scheduled based on the home delivery option or an overseas delivery option outside the country.

If it is determined, at the payment network server 108, that the payee is available to deliver to the location indicated in the transaction request 112, a response message to process the transaction request may be generated and sent to the payer transaction module 154. Additionally, the payment network server 108 may generate and send a notification message to the payer transaction module 154, notifying the payer to select an alternative delivery option (e.g., pick-up at the payer location) if it is determined, at the payment network server, that the payee is not available to deliver to the location.

In response to the receipt of the response message, a payment message may be received at the payer transaction module 154. The payment message may prompt the payer to enter the account details relating to an account to be used for processing the transaction request 112. In an embodiment, the payer may be re-directed to a payment module 156 like Masterpass® for payment purposes. That is, the payment module 156 is configured to receive the account details and forward them to the payment network server 108 which is configured to facilitate payment for the transaction request 112 through other servers (e.g., the issuer server 110) in a manner described in FIG. 1A. In an alternative embodiment, the payer transaction module 154 may be configured to perform the functions of the payment module 156. That is, the payer transaction module 154 and the payment module 156 may be one module.

For processing the payment, the payer may be directed to the payment module 156. In response to receiving an amount corresponding to each of the one or more products using the account, the payment network server 108 may generate a token (e.g., a bar code or a QR code) indicating that the one or more products in the transaction request 112 are ready for delivery. The token may be displayed on the payer device on which the payer transaction module 154 is being executed. The payee may use the payee transaction module 158 to scan the token so as to verify that the payment for the one or more products indicated in the transaction request has been made.

FIG. 2 shows a flow chart 200 illustrating a computer-implemented method for processing a transaction request at a payee location using a payer transaction module. The payer transaction module is executed on a payer device which is in communication with a payment network server 108.

The method 200 broadly includes:
step 202: Receiving, at the payer transaction module effecting on a payer device, a transaction request indicating a first product and a second product to be purchased from a payee, the first product having a first delivery option and the second product having a second delivery option;
step 204: Forwarding, to the payment network server, the transaction request;
step 206: Receiving, at the payer transaction module, a response message to process the transaction request if it is determined at the payment network server that the payee is available to carry out the first and second delivery options for delivering the first and second products respectively.

Prior to step 202, which is prior to the receipt of transaction request, the method comprises receiving, at the payer transaction module, information relating to the payee. This may be at a step of registering the payee as a user of a payee transaction module. The information relating to the payee may be forwarded to the payment network server. Additionally, the payee may provide information relating to a list of delivery options that the payee offers which may be forwarded and sent to the payer transaction module.

At step 202, the method includes receiving, at a payer transaction module effecting on a payer device, a transaction request indicating a first product and a second product to be purchased from a payee, the first product having a first delivery option and the second product having a second delivery option. The first product and the second product may be the same product (e.g., a pair of sneakers). Alternatively, the second product may be different from the first product. Each of the first product and the second product has a corresponding preferred delivery option, that is, the first delivery option and the second delivery option, respectively. In one example, the payer may want to deliver the first product by the first delivery option which is picking it up from the payee location (or “Take away” option) and deliver the second product by the second delivery option which is delivering it to a preferred location (or “Home Delivery” option). In other words, the first delivery option and the second delivery option are among the delivery options that the payee offers and indicates at the time of registering itself as a user of the payee transaction module prior to step 202.

At step 204, the transaction request is forwarded to the payment network server which is configured to perform functions, additional to facilitating payment. In various embodiments, the payment network server may be configured to determine if the payee is available to carry out the first and second delivery options for delivering the first and second products respectively. For example, if one of the first and second delivery options is a home delivery option, the payment network server may be configured to determine if the payee is available to carry out the home delivery option. Further, the payment network may determine the purchasing behavior of a payer associated with the payer transaction module at which the transaction request is received. In response to the determination of the purchasing behavior of the payer, the payment network server may then determine if there is one or more promotions for a corresponding one or more payees in response to the determination of the purchasing behavior of the payer. When one of the first and second delivery options is a home delivery, the payment network server may be configured to determine if there are one or more promotions relating to the first or second product based on the location relating to the home delivery option. For example, when the first delivery option is a home delivery option within a city in which the payee location is at and the second delivery options is a take home option from the payee location, the method may receive, at the payer transaction module, one or more promotions relating to the first product in response to a determination, at the payment network server, of the one or more promotions based on a location relating to the home delivery option within the city for delivering the first product. Alternatively, when the first delivery option is a delivery option outside a country in which the payee location is at and the second delivery options is a take home option from the payee location, the method may receive, at the payer transaction module, one or more promotions relating to the first product in response to a determination, at the payment network server, of the one or more promotions based on a location relating to the delivery option outside a country in which the payee location is at. Additionally or alternatively, when the first delivery option is a home delivery option within a city in which the payee location is at and the second delivery options is a delivery option outside a country in which the payee location is at, the method may receive, at the payer transaction module, one or more promotions relating to the first product in response to a determination, at the payment network server, of the one or more promotions based on a location relating to at least one of (i) the home delivery option within a city in which the payee location is and (ii) at the delivery option outside a country in which the payee location is at.

At step 206, the method comprises receiving at the payer transaction module, a response message to process the transaction request if it is determined at the payment network server that the payee is available to carry out the first and second delivery options for delivering the first and second products respectively. Additionally, the method comprises the results of the determinations carried out in step 204. For example, the method comprises receiving, at the payer transaction module, a notification message notifying the payer to select an alternative delivery option if it is determined, at the payment network server that the payee is not available to deliver to the location; the alternative delivery option comprises picking the first or second product from the payee location.

Subsequent to step 206, the method may comprise receiving, at the payer transaction module, a payment message in response to a receipt of the response message; receiving, at the payer transaction module, account details relating to an account to be used for processing the transaction request; and sending, to the payment network server, the account details. This may be done subsequent to a selection of an alternative delivery option if the first or second delivery option is not available. In other words, payment may be arranged only after the delivery option is determined for the selected product.

Subsequent to receiving the account details, the method comprises receiving, at the payer transaction module, a token to deliver the first or second product indicated in the transaction request in response to a determination, at the payment network server, that an amount corresponding to each of the one or more products has been received using the account. In the event that the first or second delivery option include picking the one or more products from the payee location at which the transaction request is received, displaying, at the payer device, the token; and receiving, at the payer transaction module, an approval message to pick the one or more products from the payee location when it is determined at the payment network server that the amount corresponding to each of the one or more products has been received using the account.

FIG. 2B illustrates an example of how the payer and the payee may register or use the payer transaction module and the payee transaction module respectively.

At 220, the respective module is opened by either the payer or the payee. If a consumer (or a payer) opens the module as shown in 221 for the first time, he will be directed to register as a user as shown in 222. Details relating to the consumer may be provided at 226. The details include, among other things, first name, last name, telephone number, address, e-mail address, password and location details. These details may be forwarded and saved in the database that is operatively connected to the payment network server 108. The consumer will then be directed to a main screen shown in 228. On the main screen, merchants who are registered on a corresponding payee transaction module may be displayed. On the main screen, the consumer may see one or more merchants who are registered on a corresponding payee transaction module and the on-going promotions corresponding to the one or more merchants, if any. Additionally, on the main screen, the consumer may be presented with an option to scan a bar code or a QR code on a product.

At 223, the consumer may sign in based on an identifier that was used to register for the payer transaction module. The identifier may be an email address or a mobile phone number 221(a). When the consumer is signed in successfully, he will see the main screen as shown in 228.

If a merchant (or a payee) opens the module as shown in 231 for the first time, he will be directed to register as a user as shown in 232. Details relating to the consumer may be provided at 236. The details include, among other things, company name, branch name, telephone number, address, e-mail address, password, location details, delivery options that may be offered. The delivery options may include door-to-door delivery and overseas delivery. These details may be forwarded and saved in the database (or database 109) that is operatively connected to the payment network server 108. The merchant will then be directed to a main screen shown in 238. On the main screen, customers who are on-time 238(b), QR-code/bar 238 (a), and on-going promotions 238 (c) may be displayed. The merchant may receive information relating to the prices from the database 237 which may be displayed on the main screen 238. Additionally, on the main screen, the merchant may be presented with an option to scan a bar code or a QR code that may be displayed on a payer device 242. Inputs that are received at the payee transaction module may be saved and sent to the consumer 248. Alternatively, it may be exported as a document 244.

FIG. 2C illustrates an example of how the payer may use the payer transaction module to initiate a transaction request so as to purchase a product.

At step 260, a consumer enters a shop belonging to a merchant who is a registered use of the transaction module. At 262, the consumer scans the QR code at the merchant place. At 264, the merchant will get initialized after the QR code is scanned and the consumer may get a notification for delivery to a specific location. The consumer may now select the products that he would like to buy by capturing the product image as shown in 268(a), or scanning a bar code as shown in 268(b), or a RFID as shown in 268 (c), or entering details of the product as shown in 268(d). In response to the input from the consumer, the corresponding prices of the products may be retrieved from a database.

Subsequently, the consumer may see the corresponding price for the product that he has selected, along with corresponding delivery options that are offered in 276. That is, the screen may get spilt into three options, namely “Take away,” “Shipment” or “Home delivery” as shown in 278. The option of “Home delivery” may be presented in response to the acceptable distance for home delivery that the merchant enters at the time of registering for the module. The option of “Take away” may refer to the consumer taking the product from the merchant place. The option of “Shipment” may refer to shipping the product to a customer's preferred location (e.g., Bangalore) from a merchant place at a different location (e.g., Pune). In response to an input indicating the preferred location, it will determine if there is another retail shop for the same merchant near the preferred location (e.g., Bangalore). In the event that the product is not available at the other retail shop for the same merchant near the preferred location (e.g., Bangalore), the merchant place, at which the customer, is may have to ship the product. In the event that the product is not available at the other retail shop for the same merchant near the preferred location (e.g., Bangalore) and the merchant place, at which the customer is, does not have the ability to ship the product, the customer may get a notification that the product will be removed as the customer's selection.

At 282, the consumer may click “Next” button for payment and may get two options. At 284, the customer may be directed to a payment module, e.g., Masterpass®. At this point, if the customer would like to use Masterpass® for payment, he may have to send a notification message notifying that he would like to opt for home delivery as a preferred delivery option for one or more products. Alternatively, the customer may make payment using other means, e.g., debit card, credit card or internet banking. After payment is done at either 284 or 286, the customer will be directed back to the payer transaction module at 288. A token, e.g., a bundled bar code, a QR code or a RFID code, may be generated at 290. The token may be shown to the scanning system at the merchant at 292. Once the bill is issued, the customer may pick up the products for which “Take away” option has been selected as a preferred delivery option and leave the other products for “Home delivery” or “Shipment”. Then the customer may leave the merchant's shop at 299.

In the event that the merchant does not have the scanning capabilities, the payee transaction module that the merchant utilizes provides scanning abilities for scanning the token as shown in 294. The merchant may use the module to scan the token and have the information associated with its account as shown in 296. The merchant then has an option to send a bill to the customer in response to scanning the token as shown in 298.

In an event that the customer is inactive for a certain time period, e.g., 12 hours, after signing in to a payer transaction module, he may be logged out automatically as shown in 270. Additionally or alternatively, the payer transaction module may log the customer out if it is detected that the customer has arrived at a different merchant location where the payer transaction module may be used. It may be shown at the top of the screen that the customer has been logged out at the first merchant and is now logged in at the second merchant.

FIG. 2D illustrates a flow chart illustrating a computer-implemented method, executing on a user device, for presenting capabilities to a payer processing to select a different delivery option for a different product using a payer transaction module. At 2002, the payer transaction module may receive a selection of a first product.

Subsequent to receiving the selection of the first product, at 2004, the payer transaction module displays a list of delivery options for the first product. The list of delivery options comprises (i) a home delivery option within a city in which the payee location is at (or “Home Delivery”), (ii) a take home option (or “Take away/Take home”) and (iii) a delivery option outside a country in which the payee location is at (or “Shipment”).

At 2006, the payer transaction module receives an input indicating a first delivery option in response to displaying the list of delivery options for the first product. The first delivery option is a selection out of the list of the delivery options. That is, the first delivery option may be a (i) a home delivery option within a city in which the payee location is at (or “Home Delivery”), (ii) a take home option (or “Take away/Take home”) or (iii) a delivery option outside a country in which the payee location is at (or “Shipment”).

At 2008, the payer transaction module associates the first product with the first delivery option. That is, the payer transaction module may display the selection of the first product along with the first delivery option so as to show the association to a user.

At 2010, the payer transaction module receives a selection of a second product. The second product may the same or different than the first product. For example, the first product may be a pair of sneakers and the user would want to deliver it by Home Delivery option and the second product may also be a pair of sneaker which the user would want to deliver by a different delivery option (e.g., or “Shipment” option).

At 2012, the payer transaction module displays a list of delivery options for the second product. The list of delivery options for the second product is typically the same as that shown in step 2004. That is, the list of delivery options comprises (i) a home delivery option within a city in which the payee location is at (or “Home Delivery”), (ii) a take home option (or “Take away/Take home”) and (iii) a delivery option outside a country in which the payee location is at (or “Shipment”). This list of delivery options is typically indicated by the payee, at the time of registering for a corresponding payee transaction module. The payee is one who the payer would like to transact with.

At 2014, the payer transaction module receives an input indicating a second delivery option in response to displaying the list of delivery options for the second product. The second delivery option is a selection out of the list of the delivery options. That is, the second delivery option may be a (i) a home delivery option within a city in which the payee location is at (or “Home Delivery”), (ii) a take home option (or “Take away/Take home”) or (iii) a delivery option outside a country in which the payee location is at (or “Shipment”). The second delivery option is different than first delivery option. In other words, the difference between the first product and the second product is the type of delivery option that has been selected for it, respectively.

At 2016, the payer transaction module associates the second product with the second delivery option. That is, the payer transaction module may display the selection of the second product along with the second delivery option so as to show the association to a user. The association of the first product and the first delivery option may be shown together with the association of the second product and the second delivery option.

At 2018, the payer transaction module receives a selection of a further product. Subsequent to receiving the selection of the first product, the payer transaction module displays the list of delivery options for the further product. The payer transaction module receives an input indicating a further delivery option in response to displaying the list of delivery options for the further product.

At 2020, the payer transaction module determines if the further delivery option corresponds to either the first delivery option or the second delivery option. In the event that the further delivery option corresponds to the first delivery option or the second delivery option, the payer transaction module groups the further product with the first product or the second product, respectively.

At 2022, the payer transaction module provides an option to select an alternative delivery option if the payee is unable to carry out the delivery option selected by the user (for example, the first delivery option or the second delivery option).

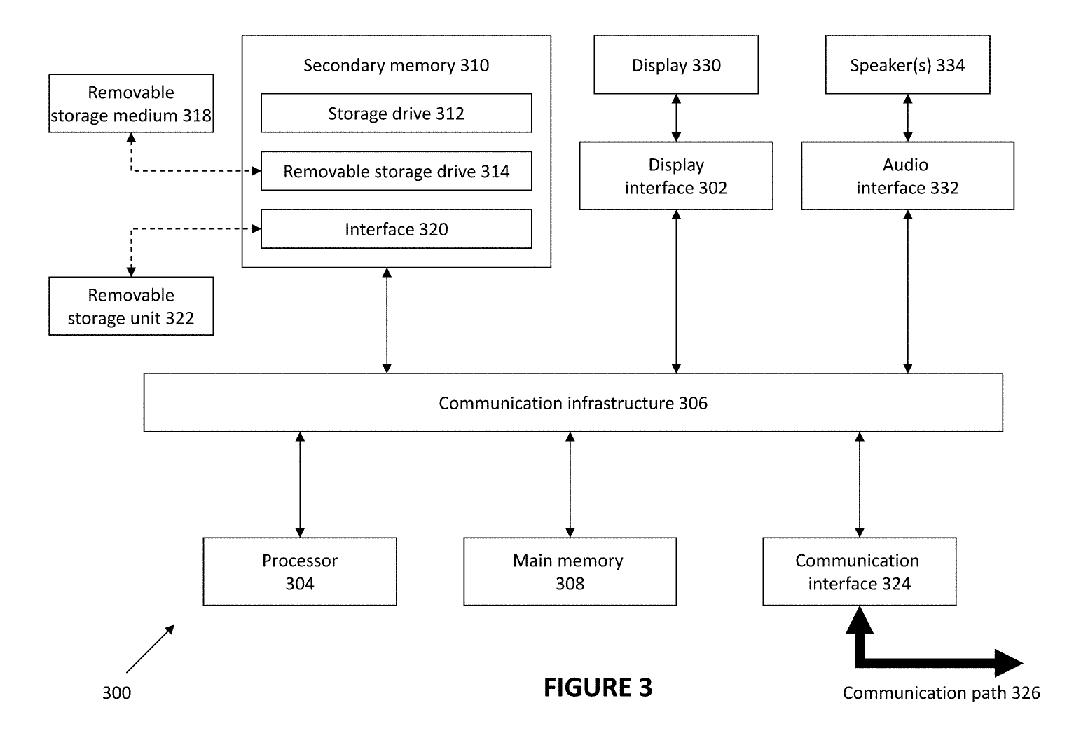

FIG. 3 depicts an exemplary computer/computing device 300, hereinafter interchangeably referred to as a computer system 300, where one or more such computing devices 300 may be used to facilitate execution of the above-described method. In addition, one or more components of the computer system 300 may be used to realize the computer 302. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 340. Examples of a removable storage unit 322 and interface 340 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 340 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments of the inventions, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ25, USB), an antenna with associated circuitry and the like. The communication interface 324 may be wired or may be wireless. Software and data transferred via the communication interface 324 are in the form of signals which can be electronic, electromagnetic, and optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 400 using the removable storage drive 314, the storage drive 312, or the interface 340. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

In an implementation, the payment network server 108 may be generally described as a physical device comprising at least one processor 402 and at least one memory 404 including computer program code. The at least one memory 404 and the computer program code are configured to, with the at least one processor 402, cause the physical device to perform the operations described in FIG. 2A. An example of the payment network server 108 is shown in FIG. 4.

For example, the method of FIG. 2A may be implemented as software and stored in a non-transitory fashion in the secondary memory 310 or the removable storage units 318, 322 of the computer device 300.

It will be appreciated by a person skilled in the art that numerous variations and/or modifications may be made to the present invention as shown in the specific embodiments without departing from the spirit or scope of the invention as broadly described. For example, the above description mainly discusses the use of a Bluetooth connection, but it will be appreciated that another type of secure wireless connection, such as Wi-Fi, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

What is claimed is:

1. A computer-implemented method for processing a transaction request at a payee location using a payer transaction module, the payer transaction module in communication with a payment network server, the method comprising:
receiving, at the payer transaction module effecting on a payer device, a transaction request indicating a first product and a second product to be purchased from a payee, the first product having a first delivery option and the second product having a second delivery option;
forwarding, to the payment network server, the transaction request; and
receiving, at the payer transaction module, a response message to process the transaction request if it is determined at the payment network server that the payee is available to carry out the first and second delivery options for delivering the first and second products respectively.

2. The method according to claim 1, further comprising:
receiving, at the payer transaction module, one or more promotions from a corresponding one or more payees in response to a determination, at the payment network server, of purchasing behavior of a payer associated with the payer transaction module.

3. The method according to claim 1, further comprising:
when the first delivery option is a home delivery option within a city in which the payee location is at and the second delivery options is a take home option from the payee location,
receiving, at the payer transaction module, one or more promotions relating to the first product in response to a determination, at the payment network server, of the one or more promotions based on a location relating to the home delivery option within the city for delivering the first product; or
when the first delivery option is a delivery option outside a country in which the payee location is at and the second delivery options is a take home option from the payee location,
receiving, at the payer transaction module, one or more promotions relating to the first product in response to a determination, at the payment network server, of the one or more promotions based on a location relating to the delivery option outside a country in which the payee location is at; or
when the first delivery option is a home delivery option within a city in which the payee location is at and the second delivery options is a delivery option outside a country in which the payee location is at,
receiving, at the payer transaction module, one or more promotions relating to the first product in response to a determination, at the payment network server, of the one or more promotions based on a location relating to at least one of (i) the home delivery option within a city in which the payee location is and (ii) at the delivery option outside a country in which the payee location is at.

4. The method according to claim 1, further comprising:
prior to the receipt of transaction request, receiving, at the payer transaction module, information relating to the payee;
forwarding, to the payment network server, the information relating to the payee; and
receiving, at the payer transaction module, a list of delivery options that the payee offers.

5. The method according to claim 1, wherein the step of receiving, at the payer transaction module, the response message to process the transaction request if it is determined at the payment network server that the payee is available to carry out the first and second delivery options for delivering each of the first and second products comprises:
determining, at the payment network server, that the payee is available to deliver to the location when one of the first and second delivery options is a home delivery option within a city in which the payee location is at or a delivery option outside a country in which the payee location is at.

6. The method according to claim 5, further comprising:
receiving, at the payer transaction module, a notification message notifying the payer to select an alternative delivery option if it is determined, at the payment network server, that the payee is not available to deliver to the location, the alternative delivery option comprises a take home option.

7. The method according to claim 1, further comprising:
receiving, at the payer transaction module, a payment message in response to a receipt of the response message;
receiving, at the payer transaction module, account details relating to an account to be used for processing the transaction request; and
sending, to the payment network server, the account details.

8. The method according to claim 7, further comprising:
receiving, at the payer transaction module, a token to deliver the first or second product indicated in the transaction request in response to a determination, at the payment network server, that an amount corresponding to each of the first and second products has been received using the account.

9. The method according to claim 8, further comprising:
when one of the first and second delivery options include a take home option from the payee location at which the transaction request is received,
displaying, at the payer device, the token; and
receiving, at the payer transaction module, an approval message to pick the corresponding first or second product from the payee location when it is determined at the payment network server that the amount corresponding to each of the one or more products has been received using the account.

10. A server for processing a transaction request at a payee location using a payer transaction module, the server comprising:
at least one processor; and
at least one memory including computer program code;
the at least one memory and the computer program code configured to, with at least one processor, causes the server at least to:
receive, from a payer transaction module effecting on a payer device, a transaction request indicating a first product and a second product to be purchased from a payee, the first product having a first delivery option and the second product having a second delivery option;
determine if the payee is available to carry out the first and second delivery options for delivering the first and the second products, respectively; and
send, to the payer transaction module, a response message to process the transaction request if it is determined that the payee is available to carry out the first and second delivery options for delivering the first and the second products, respectively.

11. The server according to claim 10, wherein the at least one memory and the computer program code is configured with the at least one processor to:
determine purchasing behavior of a payer associated with the payer transaction module; and
send, to the payer transaction module, one or more promotions from a corresponding one or more payees in response to the determination of purchasing behavior of the payer associated with the payer transaction module.

12. The server according to claim 10, wherein the at least one memory and the computer program code is configured with the at least one processor to:
determine one or more promotions based on a location relating to at least one of the first and second delivery options for delivering the first and second product, respectively, when the first delivery option is a home delivery option within a city in which the payee location is at and the second delivery options is a delivery option outside a country in which the payee location is at; and
send, to the payer transaction module, the one or more promotions in response to the determination of one or more promotions based on the location relating to at least one of the first and second delivery options for delivering the first and second product, respectively.

13. The server according to claim 10, wherein the at least one memory and the computer program code is configured with the at least one processor to:
receive, from the payment network server, the information relating to the payee; and
send, to the payer transaction module, a list of delivery options that the payee offers in response to the receipt of the information relating to the payee.

14. The server according to claim 10, wherein the at least one memory and the computer program code is configured with the at least one processor to:
determine, at the payment network server, if the payee is available to deliver to the location when the first delivery option is a home delivery option within a city in which the payee location is at and the second delivery options is a delivery option outside a country in which the payee location is at; and
send, to the payer transaction module, a notification message notifying the payer to select an alternative delivery option if it is determined that the payee is not available to deliver to the location, the alternative delivery option comprising a take home option.

15. The server according to claim 10, wherein the at least one memory and the computer program code is configured with the at least one processor to:
send, to payer transaction module, a payment message in response to the receipt of the response message;
receive, from the payer transaction module, account details relating to an account to be used for processing the transaction request;
determine if an amount corresponding to each of the first and second products has been received using the account;
generate a token to facilitate delivering the first and second products indicated in the transaction request in response to a determination that an amount corresponding to each of the first and second products has been received using the account; and
send, to the payment transaction module, the generated token.

16. The server according to claim 15, wherein the at least one memory and the computer program code is configured with the at least one processor to:
when the first delivery option comprises a delivery option outside a country in which the payee location is at and the second delivery options is a take home option from the payee location,
send, to the payer transaction module, an approval message to pick the second product from the payer venue when it is determined at the payment network server that the amount corresponding to the second product has been received using the account.

17. A computer-implemented method for processing a transaction request at a payee location using a payer transaction module, the method comprising:
receiving a selection of a first product;
displaying a list of delivery options for the first product, the list of delivery options comprising (i) a home delivery option within a city in which the payee location is at, (ii) a take home option and (iii) a delivery option outside a country in which the payee location is at;
receiving an input indicating a first delivery option;
associating the first product with the first delivery option;
receiving a selection of a second product;
displaying the list of delivery options for the second product;
receiving an input indicating a second delivery option, wherein the second delivery option is different than first delivery option; and
associating the second product with the second delivery option.

18. The method according to claim 17, further comprising:
receiving a selection of a further product;
displaying the list of delivery options;
receiving an input indicating a further delivery option; and
associating the further product with the further delivery option.

19. The method according to claim 18, further comprising:
determining if the further delivery option corresponds to either the first delivery option or the second delivery option; and
grouping the further product with the first product or the second product, respectively when it is determined that the further delivery option corresponds to either the first delivery option or the second delivery option.

20. The method according to claim 17, further comprising:
providing an option to select an alternative delivery option for at least one of the first product and the second product, the alternative delivery option being different from the first delivery option and the second delivery option, respectively.
